(19) United States
(12) Patent Application Publication
(10) Pub. No.: US 2025/0046282 A1
(43) Pub. Date: Feb. 6, 2025

(54) TONE CONTROL DEVICE FOR DIGITAL PIANO

(71) Applicant: In Heon KIM, Seoul (KR)

(72) Inventor: In Heon KIM, Seoul (KR)

(21) Appl. No.: 18/693,267

(22) PCT Filed: Aug. 11, 2022
(86) PCT No.: PCT/KR2022/012006

§ 371 Date: Oct. 14, 2024

(30) Foreign Application Priority Data
Feb. 14, 2022 (KR) 10-2022-0019001

(51) Int. Cl. G10H 1/055; G10H 1/34

(52) U.S. Cl. CPC G10H 1/0553; G10H 1/344; G10H 2220/271

(57) ABSTRACT

The present invention provides a tone control device for a digital piano, including a support forming a key or the bottom surface of a key, and a base plate disposed opposite the support below the support; wherein a first movable part, a second movable part disposed at a predetermined distance from the first movable part and aligned with the first movable part, and a counter movable part disposed at a predetermined distance from the second movable part and aligned with the second movable part are installed on the bottom surface of the support; wherein a first sensor, a second sensor, and a counter sensor are installed on the base plate, and slots are installed in the base plate; wherein, when the key is pressed, the counter sensor detects the degree to which the key has been pressed.

### TECHNICAL FIELD

The present invention relates to a tone control device for a digital piano.

### BACKGROUND ART

A digital piano is a type of keyboard contrived as an alternative to the playing style and sound of a traditional piano. This piano provides an exact simulation of an acoustic piano (an analog piano). A digital piano is designed to look like a regular piano such as an upright piano or a grand piano. The sounds of a digital piano are generated by matching the sounds, stored using synthetic emulation or actual piano samples, to the positions of touched keys and then transmitting the stored sounds through a speaker. There are three types of digital piano keyboards composed of 88, 76, and 61 keys, respectively, but the keyboard composed of 88 keys is mainly used.

Such digital pianos have the advantage of having lower maintenance costs than acoustic pianos, allow sounds to be implemented in MIDI, have built-in functions to help with learning and composition, do not require the use of a microphone, and are easy to carry. The keys of digital pianos are manufactured to feel similar to those of acoustic pianos, and are speed-responsive, so that the volumes and timbres of played sound depend on the speeds of corresponding keys. Digital pianos have hammers to give sensations similar to the touches of a real piano. Analog sensors are installed to detect the presses of keys, which makes it different from typical electronic keyboards or synthesizers. Some digital pianos have built-in pedals, but those equipped with the function of adjusting a damper by pressing a pedal for resonance, like acoustic pianos, are very expensive.

Korean Patent No. 10-1014809 proposes the key structure of a digital piano. As shown in FIG. 7, the key structure of the digital piano includes a frame 120′ configured such that a key 130′ is accommodated therein, a hammer 140′ rotatably installed on the key 130,′ and a rubber switch 150′ installed adjacent to the pivot point of the hammer 140.′ Key modules are arranged side by side at regular intervals to form 7 octaves with one module formed for one octave.

An accommodation space 122′ having a predetermined size is provided and accommodates the key 130′ composed of a white key 130a′ and a black key 130b′ without error while maintaining a preset interval. A stop protrusion 124′ is provided to prevent the key 130′ from being separated. The key 130′ includes body 132′ forming a touch part for a player and an extension part 134′ extending from the body 132.′ A catch protrusion 133a′ is provided at a predetermined position on the bottom of the body 132′ and is caught on the locking protrusion 124′ to prevent the key 130′ from being separated from the frame 120.′ The extension part 134′ is formed to extend from one side of the body 132′, and a vibration control portion 134a′ fitted over an elastic member 170′ and vertically formed through the extension part 134′ is provided at a predetermined position of the extension part 134.′.

The hammer 140′ includes a weight portion 142′ having a weight 142a′ and a rotational coupling portion 144′ installed on one side of the weight portion 142′ and rotatably coupled to the key 130.′ The rotational coupling portion 144′ is provided with a fixing protrusion 146′ that is fastened to one side of the key 130′ so that it can be rotatably provided.

The rubber switch 150′ is installed adjacent to the pivot point of the hammer 140.′ Referring further to FIG. 8, a rubber cap 152′ made of a rubber material is installed at a position opposite to a contact portion 162′ provided on a printed circuit board 160′, and a relief protrusion 154′ that is electrically conductive while being grounded to the contact portion 162′ is provided on the bottom side of the rubber cap 152.′ Then, when the key 10′ is pressed, it comes into contact with the contact portion 162′ disposed on the printed circuit board 160′ and they are electrically connected and turned on/off. A fitting protrusion 155′ is fitted into a coupling hole 166′ formed through the printed circuit board 160′.

As shown in FIG. 9, the tone control of a current digital piano is performed in a rubber dome 100′ corresponding to the relief protrusion 154.′ On the bottom surface of the rubber dome 100,′ a first rubber dome 102′ inserted in a long column and a second rubber dome 104′ disposed in a relatively short column are provided, and a first contact part 102a′ and a second contact part 104a′ are placed on the PCB board 106′ opposite the first and second rubber domes 102′ and 104.′ Even when the bottom surface of a key 100k′ remains parallel and the rubber dome 100′ is pressed, the first rubber dome 102′ comes into contact with the first contact portion 102a′ first, and the second rubber dome 104′ comes into contact with the second contact portion 104a′ later due to the height difference.

In this case, when the player presses the key 100k, ‘adjustment is performed such that, depending on the difference T between the time at which the first rubber dome 102’ and the first contact part 102a′ come into contact with each other and the second rubber dome 104′ and the second contact part 104a′ come into contact with each other, a large volume is produced when the time difference T is small and a small volume is produced when the time difference T is large. In other words, it is a speed-response formula in which the faster the player presses the key, the larger the volume becomes, and the slower the player presses the key, the smaller the volume becomes.

However, in this manner, in an acoustic piano, it is not possible to achieve the effect of producing a large volume when the key is pressed hard, or deeply, and producing a small volume when the key is pressed lightly, or a little. Depending on the depth at which the key is pressed, effects such as not only volume but also timbre, strength, and softness will vary, but the current digital pianos have limitations on not reflecting this function therein.

The present invention has been conceived to solve at once the problems of the prior art and preceding patent described above.

### DISCLOSURE

### Technical Problem

Therefore, from a completely different perspective from the prior art, an object of the present invention is to provide a new type of tone control device for a digital piano that can control velocity to adjust a tone according to the amount of pressing of a key of a digital piano, i.e., the movement distance of the key.

### Technical Solution

In order to accomplish the above object, the present invention provides a tone control device for a digital piano, the tone control device including a support forming a key or the bottom surface of a key, and a base plate disposed opposite the support at a predetermined distance from the support and below the support; wherein a first movable part, a second movable part disposed at a predetermined distance from the first movable part and aligned with the first movable part, and a counter movable part disposed at a predetermined distance from the second movable part and aligned with the second movable part are installed on the bottom surface of the support; wherein a first sensor, a second sensor, and a counter sensor configured to detect the first movable part, the second movable part, and the counter movable part, respectively, are installed on the base plate, and slots configured to allow the first movable part, the second movable part, and the counter movable part to pass therethrough when the first movable part, the second movable part, and the counter movable part are moved downward are formed in the base plate; and wherein, when the key is pressed, the counter sensor detects the degree to which the key has been pressed according to the downward movement of the counter movable part.

The first sensor may detect the time when the first movable part passes the first sensor when the key is pressed, and the second sensor may detect the time when the second movable part passes the second sensor when the key is pressed.

The tone control device may include a control unit configured to adjust a tone of the digital piano, and the control unit may determine a primary velocity based on the time difference between the passage time of the first movable part measured by the first sensor and the passage time measured by the second sensor.

The control unit may determine a final velocity by increasing or decreasing the primary velocity according to the amount of downward movement of the counter movable part measured by the counter sensor.

The counter movable part may be configured such that light-blocking portions and light-transmitting portions are repeatedly arranged in a plurality of rows along the height direction from the bottom, and the counter sensor may detect the amount of downward movement of the counter movable part by counting the number of passing light-blocking portions or light-transmitting portions when the key is pressed.

Each of the first, second, and counter sensors may include a color sensor, an optical sensor, an infrared sensor, or a photo interrupter.

Furthermore, the present invention provides the tone control device, further including a keyboard light-emitting system including an MCU disposed on the main board and a keyboard configured to communicate serially with the MCU, wherein the MCU is connected to a wireless or wired device; wherein a plurality of LED lights are installed on the keyboard; and wherein an app or program configured to control the color and intensity of each of the LED lights on the keyboard is installed in the wireless or wired device, and allows a user to actively set and input a color that the LED light emits and the intensity of the color.

Furthermore, the present invention provides the tone control device, further including a keyboard light-emitting system including an MCU disposed on the main board and a keyboard configured to communicate serially with the MCU, wherein the MCU is connected to a wireless or wired device; wherein a plurality of LED lights are installed on the keyboard; and wherein an app or program configured to select the color of each of the LED lights on the keyboard is installed in the wireless or wired device, allows a user to actively set and input a color that the LED light emits, and also allows the intensity of the color to be automatically adjusted according to a final velocity.

Furthermore, the present invention provides a tone control device for a digital piano, the tone control device including a support forming a key or a bottom surface of a key, and a base plate disposed opposite the support at a predetermined distance from the support and below the support, wherein a counter movable part is installed on the bottom surface of the support;
wherein a counter sensor configured to detect the counter movable part is installed on the base plate, and the counter movable part is configured such that light-blocking portions and light-transmitting portions are repeatedly arranged in a plurality of rows along the height direction from the bottom, and the counter sensor detects the amount of downward movement of the counter movable part by counting the number of passing light-blocking portions or light-transmitting portions when the key is pressed.

Furthermore, the present invention provides a tone control device for a digital piano, the tone control device including a support forming a key or a bottom surface of a key, and a base plate disposed opposite the support at a predetermined distance from the support and below the support, wherein a counter movable part is installed on the bottom surface of the support;
wherein a counter sensor configured to detect the counter movable part is installed on the base plate, and the counter movable part is configured such that light-blocking portions and light-transmitting portions are repeatedly arranged in a plurality of rows along the height direction from the bottom, and the counter sensor detects the amount of downward movement of the counter movable part by counting the number of passing light-blocking portions or light-transmitting portions when the key is pressed.

### Advantageous Effects

The present invention controls a tone, including an increase and decrease in volume, according to the movement distance of a key of a digital piano, i.e., the degree of pressing of the key, so that it has the same effect as that when a key of an analog piano is pressed, and allows a player to play realistic music by making full use of the player's skills.

The present invention displays various colors through keys when a digital piano is played, and the brightness of each of the colors varies depending on the degree to which a corresponding key is pressed, so that the audience's attention is focused and the mood is raised, thereby increasing the marketability of the digital piano.

The present invention enables a player or user to generate a colorful atmosphere by actively setting colors and the intensities of the colors in advance before playing by using a wireless device.

### DESCRIPTION OF DRAWINGS

FIG. 2 is a diagram illustrating a case where a user presses a key on a tone control device for a digital piano according to an embodiment of the present invention;

FIG. 3 is a diagram of the configuration of a tone control device for a digital piano according to another embodiment of the present invention;

FIG. 4 is a diagram showing a case where a user presses a key on the tone control device for a digital piano according to the embodiment of FIG. 3;

FIG. 5 is a diagram of a keyboard light-emitting system of the present invention;

FIG. 6 is a diagram showing an example of an LED control guide provided by an app of a wireless device;

FIG. 7 is a diagram showing the key structure of a prior art digital piano;

FIG. 8 is a diagram showing the rubber unit of the key structure of FIG. 1;

FIG. 9 is a diagram illustrating a volume control method for a digital piano according to current commercial technology; and

FIG. 10 is a diagram illustrating a method of controlling volume according to a time difference in the prior art of FIG. 3.

### BEST MODE

Each embodiment according to the present invention is merely an example to help to understand the present invention, and the present invention is not limited to the embodiment. The present invention may include a combination of one or more of the individual components and individual functions included in each embodiment.

The present invention is characterized in that in order to control a tone of a digital piano, volume is by taking into consideration a parameter adjusted attributable to the depth of pressing of a key in addition to velocity attributable to a speed difference.

### MODE FOR INVENTION

FIG. 1 is a diagram of the configuration of a tone control device 1 for a digital piano according to an embodiment of the present invention.

The tone control device 1 of the present invention includes an upper support 100 and a base plate 200 installed in a lower portion opposite to the support 100.

The support 100 may be a key itself or part of a key. Alternatively, it may be implemented as a base that is separately attached to the bottom of a key. The support 100 has a rectangular key shape, but is not limited thereto. The support 100 needs to reflect the pressing depth and movement trajectory of the key in accordance with the pressing of the key.

On the bottom surface of the support 100, there are included a first movable part 104, a second movable part 106 disposed at a predetermined distance from the first movable part 104 and aligned with the first movable part 104, and a counter movable part 108 disposed predetermined distance from the second movable part 106 and aligned with the second movable part 106.

The first movable part 104, the second movable part 106, and the counter movable part 108 are aligned and installed along the same line in the left and right directions of the drawing, i.e., in the longitudinal direction of the support 100, and preferably along the center line on the bottom surface of the support 100. They are manufactured to a height that sufficiently passes through the base plate 200 when the support 100 is pressed.

Although the first movable part 104 and the second movable part 106 are each shown in the shape of a rectangular bar with a narrow width and a long height, they may be implemented in various shapes, such as a circular column shape. Additionally, they may be made of various materials such as rubber, plastic, and metal.

The counter movable part 108 is similar to the first movable part 104 in terms of an overall shape, except that horizontal bar-shaped light-blocking portions 108a, . . . , 108a are arranged at predetermined intervals along the height direction from the bottom and light-transmitting portions 108b, . . . , 108b are formed therebetween. The material of the light-blocking portions 108a, . . . , 108a is the same as that of the first movable portion 104, but the material of the light-transmitting portions 108b, . . . , 108b may be made of a light-transmitting material or transparent glass, or may be provided as empty spaces.

In the base plate 200, slots 202 configured such that the first movable part 104, the second movable part 106, and the counter movable part 108 pass therethrough are formed opposite the bottom surfaces of the upper members. A first sensor 304, a second sensor 306, and a counter sensor 308 are installed on the top surface of the base plate 200 on sides adjacent to the respective slots 202. These sensors are preferably member detection sensors using light or wavelength, such as color sensors, optical sensors, infrared sensors, or photo interrupters. In FIG. 1, sideways “U”-shaped photo interrupters are shown as an example. A transmissive photo interrupter is an optical switch that detects the presence or absence of an object by arranging a light-emitting element and a light-receiving element to face each other in one package and blocking light when a detect target object passes between them.

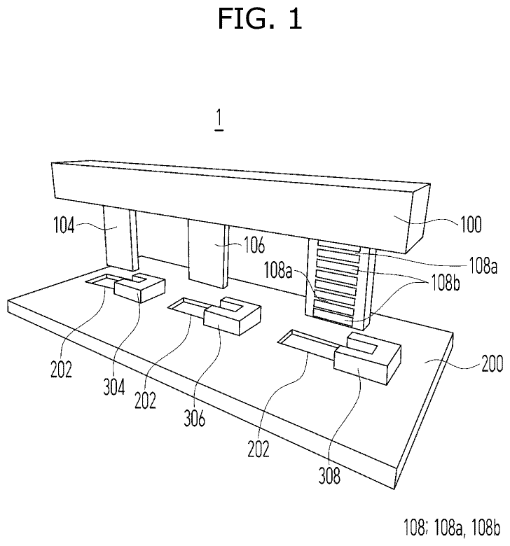

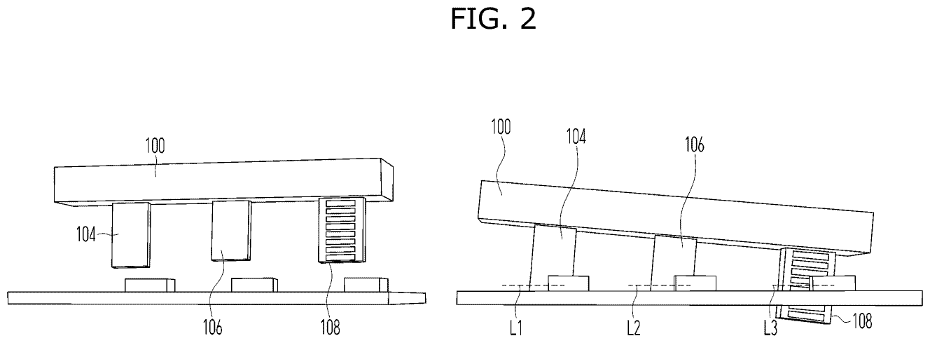

FIG. 2 is a diagram illustrating a case where a user presses a key on the tone control device 1 for a digital piano according to an embodiment of the present invention. It is assumed that the right side of the drawing is where the user sits and presses keys.

In FIG. 1, when the user presses the key, the support 100 follows the movement trajectory of the key, so that as shown in FIG. 2, the right end of the support 100 is tilted the most and the left end thereof is pressed to have an inclination intended to maintain the original position thereof as much as possible.

In terms of time, the counter movable part 108 passes through the slot 202 first, then the second movable part 106 passes through the slot 202, and finally the first movable part 104 passes through the slot 202. However, in terms of function, the counter movable part 108 does not need to pass through the base plate 200 first. Furthermore, the first movable part 104 does not necessarily have to pass through the slot 202 after the second movable part 106, and it is important to measure the time difference.

For the sake of convenience, a velocity adjusting process for controlling a tone of a digital piano according to the present invention will be described based on the sequence illustrated in FIG. 2 as follows. Although “velocity” means speed, it needs to be broadly interpreted to mean a pitch control variable with the pressing depth of a key taken into consideration in addition to speed (a time difference) in the present invention.

The velocity adjustment of the present invention to be described below is preferably performed in the control unit of the main board of the digital piano. The main board has communication lines configured to communicate with volume control members for respective keys and an input/output interface, which are connected to the control unit along with memory.

First, the time when the second movable part 106 crosses the measurement level L2 of the second sensor 306 is measured. Next, the time when the first movable part 104 crosses the measurement level L1 of the first sensor 304 is measured. Then, based on these data, the time difference Td between the two times is calculated. Even when the time for the measurement level L1 is measured first and the time for the measurement level L2 is measured later, the result is the same, and the sequence of the measurement is not limited. Although the measurement levels L1, L2 and L3 are set to the intermediate positions through which the transmitting units and receiving units the sensors face each other, they may be set to other positions as long as they provide the same reference lines or depending on the specifications of the sensors.

The time difference Td is a first variable that controls a volume of a piano. The faster a player presses the key, the smaller the time difference Td becomes. The slower a player presses the key, the larger the time difference Td. The smaller the time difference Td, the faster the key speed, so that the volume is increased. Although this principle is similar to the speed-response equation of the prior art, the present invention differs in that it uses a light detection sensor rather than a rubber dome and a contact part. Accordingly, than the prior art, the present invention may perform more precise volume control, and design and manufacturing are more simple because there is no need to add physical structures such as a rubber dome and a contact part. In particular, the accuracy of the sensors may be improved because each of the sensors only needs to measure the time when each of the movable part crosses the reference level based on the reference level.

Furthermore, in the present invention, the pressing depth of the key is measured using the counter movable part 108 and the counter sensor 308.

As the counter movable part 108 moves downward when the key is pressed, the number of light-blocking portions 108a, . . . , 108a crossing the measurement level L3 of the counter sensor 308 changes. When the key is pressed to the lowest depth, the number is “0.” The number of light-blocking portions 108a, . . . , 108a may reach up to “9.” As the light-blocking portions 108a, . . . , 108a and the light-transmitting portions 108b, . . . , 108b alternately and sequentially cross the reference level L3, values of, e.g., “0” (low) and “1’ (high) are repeatedly detected, so that it is easy to cumulatively count the number of “0”s and thus it is easy to design the sensor accordingly.

In the present invention, when a normal press is made, i.e., when the user presses the key for a normal volume, the number of light-emitting portions having crossed the measurement level L3 is set as a reference state (e.g., a reference counter N=3). When a counter is higher than this number, it is determined that the key has been pressed more deeply than normal. The value of a primary velocity V1, which is preliminarily determined based on the time difference Td, is increased by a predetermined value α. Conversely, when the counter is lower than the number, it is determined that the key has been pressed more lightly than normal, and thus the value of the primary velocity V1, which is preliminarily determined based on the time difference Td, is reduced by a predetermined value α. It is obvious that the predetermined value is different depending on the number of the counter, and the absolute value of the predetermined value increases as the distance of the predetermined value from the reference value increases.

The secondary velocity V2 as the final value determined in this manner will be determined as follows.

$$V 2 = V 1 \pm α$$

The value of the primary velocity V1 may be obtained using data on the contact time difference using the existing rubber dome. Since the tone control device for a digital piano according to the present invention has a structure different from that of the existing one, so that it may be necessary to perform calibration or initialization through repeated keystrokes. The predetermined value α may be set, for example, so that V2 ranges from half to twice V1, and varies depending on the number of light-blocking portions 108a, . . . , 108a counted by the counter.

Although the above description has described the cumulative counting of the number of light-blocking portions 108a, . . . , 108a having crossed the reference level L3, it is that conversely, it may also be possible to cumulatively count the number of light-transmitting portions 108b, . . . , 108b having crossed the reference level L3.

In terms of the structure, the smaller the height of each of the light-blocking portions 108a, 108a and the more rows the horizontal pattern of the light-blocking portions 108a, . . . , 108a is formed to have, the more accurately the pressing depth of the key may be reflected in the calculation of the velocity.

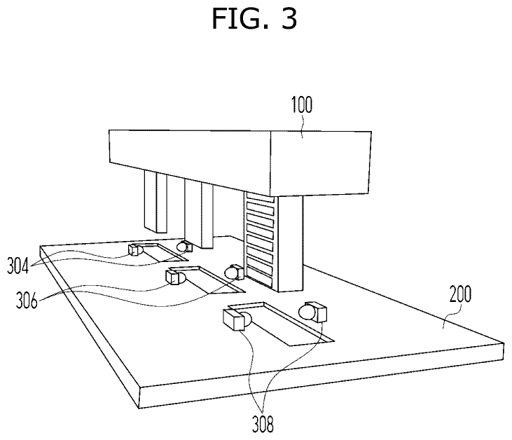

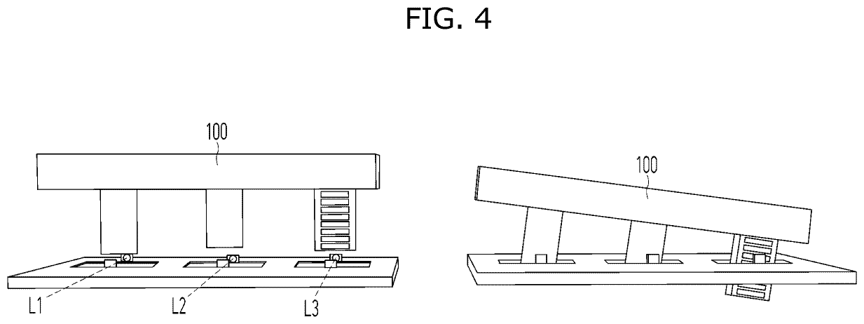

FIG. 3 is a diagram of the configuration of a tone control device 1 for a digital piano according to another embodiment of the present invention, and FIG. 4 is a diagram showing a case where a user presses a key on the tone control device 1 for a digital piano according to the embodiment of FIG. 3.

In another embodiment of the present invention, each of the first, second and third sensors 304, 306, and 308 is configured such that a pair of light-receiving unit and light-transmitting unit are arranged to face each other with each of the slots 202 therebetween, instead of a sideways “U”-shaped photo interrupter. The measurement levels L1, L2, and L3 are set to the intermediate positions of the dotted lines along which the light-receiving unit and the light-transmitting unit face each other.

Even in this case, the functions described in FIGS. 1 and 2 can be achieved, so that detailed descriptions thereof will be omitted.

When a color sensor is used, the counter movable part is formed using two different colors, and the color sensor is used to count the number of the same colors having crossed the reference level L1.

Next, a keyboard light-emitting system 500 of the present invention will be described.

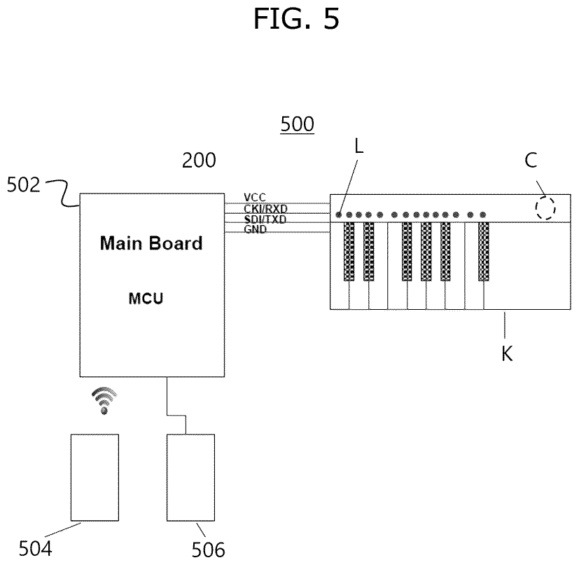

As shown in FIG. 5, the keyboard light-emitting system includes an MCU 502 disposed on a main board and a keyboard K configured to perform serial communication with the MCU. The MCU 502 may be wirelessly connected to a wireless device 504 such as a mobile phone, and may also be connected to an external terminal 506. A plurality of LED lights L, . . . , L are installed on the top side of the keyboard K. The light emission control of the LED lights L, . . . , L is performed by an LED control unit C, which receives signals from the MCU 502 via serial communication.

An app or program is installed in the wireless device 504 to control the colors and intensities of the LED lights of the keyboard. By running the app or program, a user may set the colors (red, pink, blue, green . . . , etc.) emitted by the LED lights L, . . . , L and the intensities (condensations) of those colors. For example, even when colors in question are the same pink color, light pink and dark pink have different intensities and generate different impressions and aesthetic sensations for people around them.

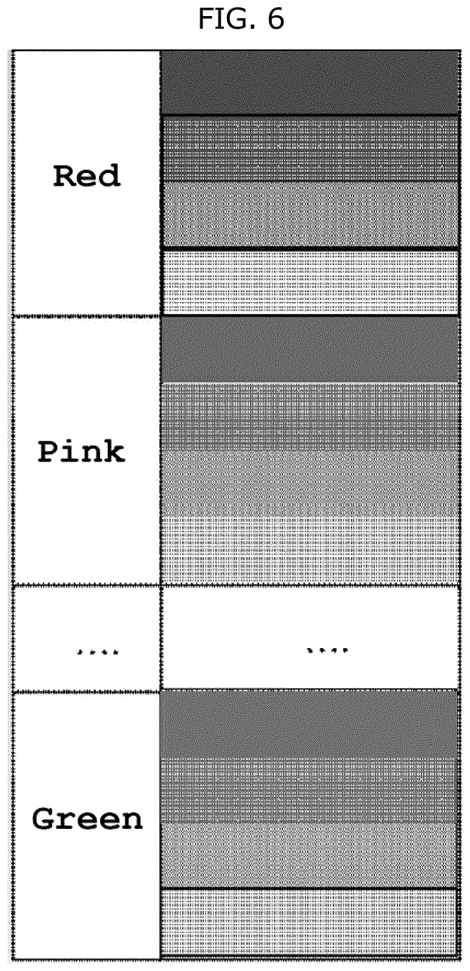

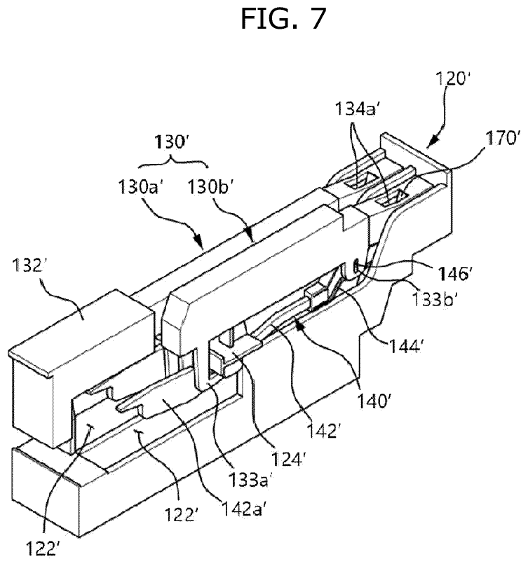

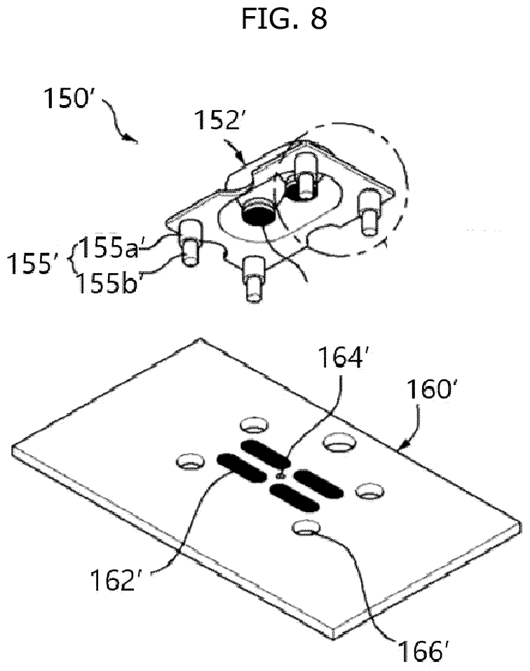

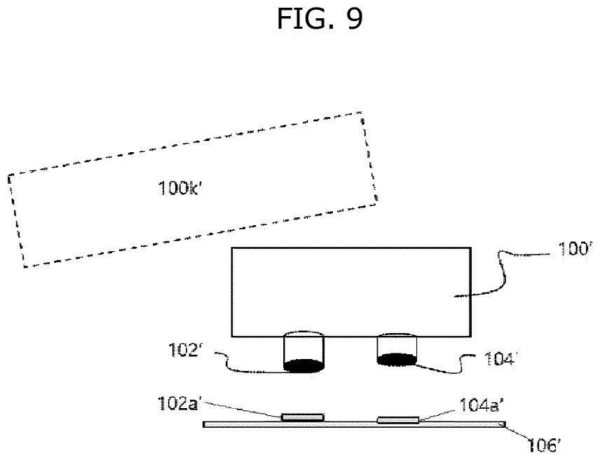

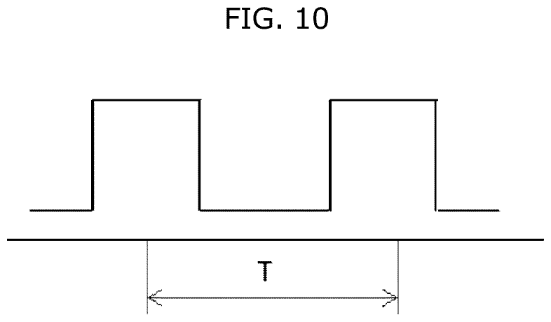

FIG. 6 shows an example of an LED control guide provided by the app of the wireless device 504, which is an example in which representative colors and sub-colors corresponding to respective intensities are displayed on a table so that a user can easily enter a sub-color by touching it.

The advantage of the present invention lies in that settings are made such that when a player makes a loud sound by pressing a key deeply, the intensity of a corresponding color is increased, and, in the opposite case, the intensity of the color is decreased, these signals are transferred to the MCU 502, and the LED lights L, . . . . L are allowed to emit various types of light.

Alternatively, a player may set only a color in advance, and the MCU 502 or the LED control unit C may automatically adjust the condensation of the color attributable to the pressing of a key according to a finally determined velocity value.

When the keyboard light-emitting system 500 of the present invention is used, a method (for a block piano) may be used in which signals are received through the MCU 502 of the main board and the LED control unit C of the keyboard K directly controls the LED lights L, . . . . L, or a method (for a general digital piano) may be used in which the MCU 502 of the main board controls the LED lights L, . . . , L without the intervention of the LED control unit C.

The external terminal 506 may connect to the MCU 502 via a wired connection and function like the wireless device 504.

Although the embodiments of the present invention have been described above, this does not limit the present invention, and various alterations and modifications may be made to the present invention. For example, the present invention may be applied to the existing structure of a digital piano in such a manner as to provide a counter movable part and a counter sensor while using the existing rubber dome method and adjust a velocity according to the pressing distance of a key or in another manner.

It is obvious that the scope of rights of the present invention extends to the scope identical or equivalent to the claims to be described below.

1. A tone control device for a digital piano, the tone control device comprising a support forming a key or a bottom surface of a key, and a base plate disposed opposite the support at a predetermined distance from the support and below the support;
wherein a first movable part, a second movable part disposed at a predetermined distance from the first movable part and aligned with the first movable part, and a counter movable part disposed at a predetermined distance from the second movable part and aligned with the second movable part are installed on a bottom surface of the support;
wherein a first sensor, a second sensor, and a counter sensor configured to detect the first movable part, the second movable part, and the counter movable part, respectively, are installed on the base plate, and slots configured to allow the first movable part, the second movable part, and the counter movable part to pass therethrough when the first movable part, the second movable part, and the counter movable part are moved downward are formed in the base plate;
wherein, when the key is pressed, the counter sensor detects a degree to which the key has been pressed according to a downward movement of the counter movable part;
wherein the first sensor detects a time when the first movable part passes the first sensor when the key is pressed, and the second sensor detects a time when the second movable part passes the second sensor when the key is pressed; and
wherein the tone control device includes a control unit configured to adjust a tone of the digital piano, and the control unit determines a primary velocity based on a time difference between a passage time of the first movable part measured by the first sensor and a passage time measured by the second sensor.

2. The tone control device of claim 1, wherein the control unit determines a final velocity by increasing or decreasing the primary velocity according to an amount of downward movement of the counter movable part measured by the counter sensor.

3. The tone control device of claim 4, wherein the counter movable part is configured such that light-blocking portions and light-transmitting portions are repeatedly arranged in a plurality of rows along a height direction from a bottom, and the counter sensor detects the amount of downward movement of the counter movable part by counting a number of passing light-blocking portions or light-transmitting portions when the key is pressed.

4. The tone control device of claim 1, wherein each of the first, second, and counter sensors includes a color sensor, an optical sensor, an infrared sensor, or a photo interrupter.

5. The tone control device of claim 1, further comprising a keyboard light-emitting system including an MCU disposed on the main board and a keyboard configured to communicate serially with the MCU, wherein the MCU is connected to a wireless or wired device;
wherein a plurality of LED lights are installed on the keyboard; and
wherein an app or program configured to control a color and intensity of each of the LED lights on the keyboard is installed in the wireless or wired device, and allows a user to actively set and input a color that the LED light emits and an intensity of the color.

6. The tone control device of claim 1, further comprising a keyboard light-emitting system including an MCU disposed on the main board and a keyboard configured to communicate serially with the MCU, wherein the MCU is connected to a wireless or wired device;
wherein a plurality of LED lights are installed on the keyboard; and
wherein an app or program configured to select a color of each of the LED lights on the keyboard is installed in the wireless or wired device, allows a user to actively set and input a color that the LED light emits, and also allows an intensity of the color to be automatically adjusted according to a final velocity.

7. The tone control device of claim 1, wherein the counter movable part is configured such that light-blocking portions and light-transmitting portions are repeatedly arranged in a plurality of rows along a height direction from a bottom, and the counter sensor detects the amount of downward movement of the counter movable part by counting a number of passing light-blocking portions or light-transmitting portions when the key is pressed.

8. The tone control device of claim 1, wherein the counter movable part is configured such that first color portions and second color portions are repeatedly arranged in a plurality of rows along a height direction from a bottom, and the counter sensor detects the amount of downward movement of the counter movable part by counting a number of passing first color portions or second color portions when the key is pressed.
